(19) United States
(12) Patent Application Publication
(10) Pub. No.: US 2008/0198742 A1
(43) Pub. Date: Aug. 21, 2008

(54) METHOD AND SYSTEM FOR TESTING STATEFUL NETWORK COMMUNICATIONS DEVICES

(76) Inventor: Gideon KAEMPFER, Raanana (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/027,523

(22) Filed: Feb. 7, 2008

Related U.S. Application Data
(60) Provisional application No. 60/890,495, filed on Feb. 18, 2007.

(51) Int. Cl. H04L 12/26

(52) U.S. Cl. 370/230

(57) ABSTRACT

The testing of stateful network devices at near wire-speed operation is accomplished by a tester that delivers realistic client-side and the server-side traffic to stateful network device under test, where the realistic traffic can simulate legal packets of a plurality of TCP sessions that are expected to be transferred over each connection between the tester and the device under test. The simulated traffic in a session is independent of previous states of the session or received packets. The packets are generated by the tester based on a predefined scenario. The scenario can define the type of the session (http, ftp, email, any combination of those, etc.) the content, the size of a message, number of connections in the session, missing packets, bit rates, etc. For each scenario, one or more scripts can be created. The scripts can simulate problems so that the operation of the device under test can be monitored.

### CROSS-REFERENCE TO RELATED APPLICATIONS

This is a non-provisional application for patent, filed under 37 CFR 1.53(b) and claiming priority to and the benefit of U.S. Provisional Application For Patent filed on Feb. 18, 2007 and assigned Ser. No. 60/890,495, which application is hereby incorporated by reference.

### FIELD OF THE DISCLOSURE

The subject matter of the present disclosure relates to the field of testing network communications devices and, more particularly, to testing performance of high capacity stateful network devices under heavy load.

### BACKGROUND OF THE DISCLOSURE

The capacity of today's network devices is required to increase to support the ever increasing demands for bandwidth. Common network devices can be divided into two categories: stateless devices and stateful devices.

A stateless network device is a device that makes decisions based on information that is embedded within a current received packet, usually in the header of the packet, without maintaining or using any information related to previous packets or states. A common stateless device does not maintain any type of connection with a client or a server at either end of the transaction. A few non-limiting examples of stateless devices include switches, routers, etc.

A common stateful device makes decisions based on information embedded within a current received packet, as well as information that is related to previous packets which were sent over a relevant connection. For example, in a TCP connection, if a data packet is received before receiving a synchronize (SYN) packet on the same connection, then the data packet will not be forwarded toward its final destination. Therefore, a common stateful device maintains information about the connection as well as information related to previous packets. The maintained information can include, but is not limited to source and destination IP addresses, ports, type of content, sequence numbers, etc. The information can be embedded within the IP, TCP and HTTP headers of the packet, or in higher applicative layers, such as but not limited to, HTTP headers. An HTTP header can be spread over multiple packets. Furthermore, a stateful network device may respond to a feedback indication that is related to the connection. An exemplary feedback mechanism may be used to match the speed of the traffic over the connection to the capacity of the receiver. A few non-limiting examples of stateful network devices include Server Load Balancers, Firewalls, HTTP proxies, etc.

Testing high capacity stateful network devices in real-world simulated scenarios at near “wirespeed” rate becomes complicated because the testing device, per each simulated connection, needs to maintain a plurality of states, to parse at least a portion of received packets, as well as to respond to feedback that is related to the connection.

Today, performance of stateful devices may be attempted to be measured using a common “packet blaster” tester. A “packet blaster” tester transmits packets, to the device under test (DUT), in a pattern ignoring received packets or previous transmitted packets and/or states. The blasted packets can be sent at a near wirespeed rate. However, because the sent packets do not match previous states of the connection or respond to a received packet, the simulated packets can be dropped by the device under test. Dropping the packets will not reflect the performance of the stateful network device under test, since the dropping can be legal and not a result of malfunction of the DUT.

Another testing method that is used today for testing stateful network devices is using TCP socket-based software implementations. Such a method requires multiple computing devices with multiple processors and ports to achieve the number of TCP sessions required to test a high capacity stateful network communications device. In some cases the device under test may not have enough ports to be connected to the tester. Such a method may simulate real-world scenarios taking into account previous states, received packets and feedback. The test system can check the functionality of the stateful network device. However, such a testing system is not capable of reaching the near wirespeed that is required to test the capacity of the stateful network device. Furthermore, a system having these capabilities is very expensive.

An alternate testing method in the art creates a combination of simulated sessions, in which a portion of the sessions are stateful sessions and the majority of the simulated sessions are quasi-stateful sessions. The quasi-stateful section of the simulator does not maintain the previous states of the connection. However, it can be capable of responding to received feedback on the load over the receiver side by adjusting the speed over the connection. In addition, the quasi-stateful simulator can be capable of parsing a received packet and responding with a packet that is a legal response to the received one. For example, if a received packet is a TCP SYN packet, the simulated response packet can be a TCP SYN-ACK packet, etc. In such a testing system, processing of received packets is needed to respond with an accepted packet. Therefore, in order to reach the near wirespeed performance by such a quasi-stateful simulator, a special hardware implementation is needed.

What is needed therefore is a new method for testing the performance of a stateful network device under near wirespeed conditions while reducing the price as well as the complexity of the system.

### SUMMARY OF THE DISCLOSURE

A system and method are disclosed for testing stateful network devices at near wire-speed operation. An exemplary embodiment of a stateful network device tester may deliver realistic client-side and the server-side traffic via a stateful network device under test. The realistic traffic can simulate legal packets of a plurality of TCP sessions that are expected to be transferred over each connection between the tester and the device under test (DUT). However, the simulated traffic in a session is independent of previous states of the session or received packets.

Generating the packets in each TCP session by the tester is based on a predefined scenario. A scenario can define the type of the session (http, ftp, email, any combination of those, etc.) the content, the size of a message, number of connections in the session, missing packets, bit rates, etc. For each scenario, one or more scripts can be created. Each script can be described by a list of molds of packets and associated context. A script can define two sub-sessions. Each sub-session defines a sub-list of molds of packets. One sub-session defines a sub-list of molds of packets that could be sent by a client towards a server, a client sub-session (CSS). The other sub-session defines a sub-list of molds of packets that simulate a series of legal molds of packets that could be sent by a server in response to receiving the client packets from the first sub-list, a server sub-session (SSS).

However, transmitting the packets to each side of the DUT is independent of the status of the traffic over the other side of the device under test. For example, if in a TCP session the device under test fails to deliver one or more server response packets to a client side of the tester, then the client side of the tester will continue in the script and send the next packet in the client sub-list ignoring the fact that a response to the previous packet was not received.

Some scripts may simulate problematic events in one or both sides of the connection. A problematic event can be missing packets, latency changes, packet retransmissions etc. The other sub-session as part of simulating the same problematic events may simulate packets that match responses to expected packets that a DUT may deliver in those situations.

For example, a script may simulate a client transmitting a TCP SYN packet to the DUT, triggering the DUT to send a TCP SYN packet to the server. The server side is expected to respond with a TCP SYN-ACK packet. However, an exemplary script can avoid sending a TCP SYN-ACK packet, simulating a missing SYN-ACK packet. In this missing SYN-ACK packet event, it is expected that after a certain timeout period (TOP1) a DUT may send another TCP SYN toward the same server. Therefore a simulated sub-session of the server-side may deliver a TCP SYN-ACK packet after a delay greater than TOP1.

An exemplary embodiment of a tester system may comprise a tester configuration module (TCM), and a common stateless tester. A stateless tester can be a layer 2 and 3 tester, a packet blaster tester, such as but not limited to “TeraRouting Tester”. “TeraRouting Tester” is a trademark of Spirent Communication a company located in the state of California.

An exemplary TCM may create a set of one or more scenarios that can be simulated by the tester system. Each scenario can be translated into one or more scripts. Each script defines a list (session) of consecutive molds of packets and associated context. The list can be composed of a client sub-session (CSS) and a server sub-session (SSS). Each sub-session is described by a sub-list of molds of packets (MOP) and associated context for creating streams of packets that are sent by a client or a server (respectively) to the other side of the connection. A context may define the time intervals, ports of the DUT, latency, the content of each MOP, etc. A script may emulate different stages in a communication event and problematic events. For example, a script of retrieving a web page can include a Domain Name Server (DNS) query stage, three way handshake for TCP establishment stage, http stage, missing packets emulation, terminating stage, etc. The two sub-sessions of a script can be shifted in time in order to emulate the latency and the processing time of each end of the connection.

The list of the consecutive molds and associated context is transferred to the packet-blaster tester. The relevant context can include instructions regarding how to convert each MOP into a stream of packets, each packet slightly different from the others. The packet blaster tester per each MOP may create, based on the associated context, a stream of a plurality of packet variants up to wirespeed. Each packet variant may differ from a previous one by source and destination IP addresses, for example. The stream that is related to the next MOP in the sub-session can repeat the same set of source and destination addresses as the first stream. The created packets are independent of previous states of a connection or of received packets over the same connection.

The common layer 2 and 3 tester, which is adapted to monitor the traffic via the device under test, delivers common reports on the performance of the device. The reports may contain information regarding the latency per each packet stream or port of the device under test, number of packets that have been transferred by each stream or via each port, maximum bit rate per stream or per port, lost packets, etc. Since each packet corresponds to a specific MOP, which corresponds to a certain script, the reports can reflect the performance of the DUT under a certain script or scenario.

The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE DRAWINGS

Some various embodiments, aspects and features of the present invention are particularly pointed out and distinctly claimed in the concluding portion of the specification. Exemplary embodiments of the present invention will be more readily understood from reading the following description and by reference to the accompanying drawings, in which:

FIG. 1 illustrates a simple block diagram with relevant elements of a tester configuration module (TCM);

FIGS. 2a and 2b illustrate a flowchart showing relevant processes of an exemplary method for emulating stateful testing by implementing a stateless tester; and

FIGS. 3a and 3b illustrate a timing diagram showing exemplary two sub-sessions, each one with a sequence of molds of packets created by an exemplary web page fetcher script generator.

### DETAILED DESCRIPTION OF EXEMPLARY EMBODIMENTS

Turning now to the figures in which like numerals represent like elements throughout the several views, exemplary embodiments, aspects and features of the present invention are described. For convenience, only some elements of the same group may be labeled with numerals. The purpose of the drawings is to describe exemplary embodiments of the present invention and not for production or limitation. Therefore, features shown in the figures are chosen for convenience and clarity of presentation only. The timing between the different events in the timing diagram is chosen for convenience and clarity of presentation and is not necessarily shown to scale.

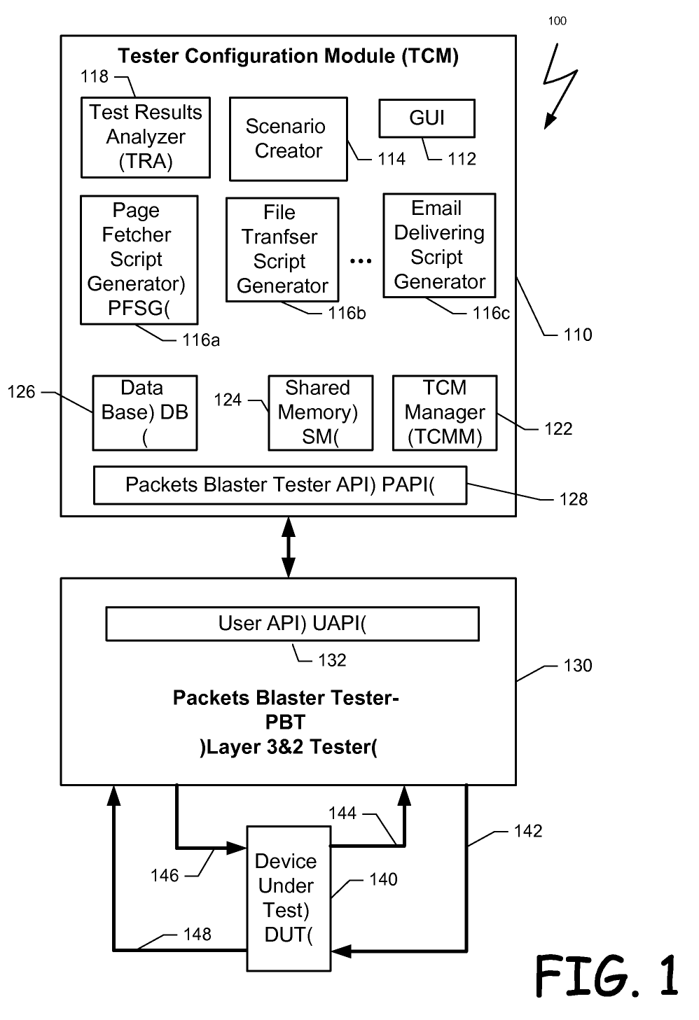

FIG. 1 illustrates a block diagram with relevant modules of an exemplary testing system 100 for testing a stateful network communications device according to an exemplary embodiment of the present invention. System 100 may comprise a tester configuration module (TCM) 110 and a common commercial stateless tester such as a “Layer 2&3 Tester”, a packet blaster tester (PBT) 130 and a DUT 140. A non-limiting example of a PBT 130 includes the “TeraRouting Tester”, a trademark of Spirent Communication a company located in the state of California. An exemplary DUT 140 can be a stateful network device, such as but not limited to, a load balancer, Firewall, proxy, etc.

An exemplary PBT 130 can be capable of receiving, via its user application program interface (UAPI) 132, a plurality of molds of packets. A mold of packets is basically a template of packets that can be easily modified or augmented to create a valid set of packets. Utilizing the template beneficially enables slight modifications to be made to create several sets of packets that can be used to exercise a DUT. Thus, each mold can be associated with a context. Based on the associated context, each mold of packets can be converted into a stream of a plurality of packets with each packet being slightly different from the other. For instance, the packets may be made different by modifying the source and/or destination IP address, TCP port number, etc. The context may include a variety of variables and characteristics, and as such may define an interval of bit rates, the number of repetitions that a stream may be repeated, an interval of repetition rates, etc. The plurality of streams can be transmitted to the DUT 140 via one or more communication lines 142, 146, for example. In an exemplary embodiment, communication line 146 can emulate a path for the traffic coming from a plurality of clients; while communication line 142 can emulate a path for the traffic coming from a plurality of servers.

An exemplary PBT 130 can be adapted to receive, via communication lines 144 and 148, packets that have been processed by the DUT 140 and are sent toward the server side over communication line 144 or to a client side over communication line 148. The illustrated numbers of communication lines (142, 144, 146 and 148) and/or sides of DUT 140 are not mandatory and can be varied from one test to the other, from one type of DUT to the other or can be based on the type of PBT 130. In some cases a single side can be used with one or more communication lines. In some cases mixed server/clients traffic can appear on a communication line.

An exemplary PBT 130 can be capable of analyzing the streams of packets received from the DUT 140 via one or more communication lines 144, 148. Based on the analysis, reports pertaining to latency issues, missing packets, etc. can be delivered. The reports can be delivered to the TCM 110 via UAPI 132. An exemplary report can indicate the time, bit rate, current load, the stream, etc. Common operation of the various components of the DUT 140 and the PBT 130 is known in the art and is not described in exhaustive detail herein. Rather, the description will focus on the various operations of the tester configuration module (TCM) 110.

An exemplary TCM 110 can be capable of configuring the PBT 130 to blast the DUT 140 via communication line 146 and 142, with a plurality of packets simulating a plurality of stateful connections between a plurality of clients and a plurality of servers. However, the packets on each side (client or server) of the DUT 140 are independent of the packets that are received from the DUT 140 and/or the status of the traffic over relevant connections at the other side of the DUT 140. For example, in a web page retrieving session, if the DUT 140 fails to deliver one or more server response packets to a client side of the PBT 130, then the client side of the tester will continue and send the next packets in the series of packets ignoring the fact that a response to the previous packet was not received.

An exemplary TCM 110 can comprise logical modules, such as a graphical user interface (GUI) module 112, a scenario creator module 114, one or more script generator modules 116a-c (one per each type of simulated transaction), test results analyzer 118, a TCM manager (TCMM) 122, a shared memory (SM) 124, a database (DB) 126 and a PBT application program interface (PAPI) 128 for interfacing with PBT 130. The SM 124 can be used for storing currently used software programs and information that are shared and used by the different modules of the TCM 110. For example, the information may include, but is not limited to, queues and states of the different modules. The DB 126 can be a database that stores previous scenarios and their associated scripts, exemplary files in different sizes, exemplary web pages in different sizes, previous results, etc. The TCMM 122 can be a module activating and utilizing the different logical modules in order to configure the PBT 130 to execute the required tests.

The TCM 110 may include a variety of script generators used for various simulated transactions. For example, one embodiment may include a web page fetcher script generator 116a, which creates a list of a plurality of molds of packets for creating packets that can be transferred between a client and one or more servers for the purpose of simulating a transaction of fetching a web page. Another script generator can be a file transfer script generator 116b that creates a list of a plurality of molds of packets for creating packets that can be transferred between a client and a server for the purpose of transferring a file. Another script generator can be an email delivering script generator 116c that creates a list of a plurality of molds of packets for creating packets that can be transferred between a mail client and a mail server in order to send and/or receive emails, etc.

GUI 112 can prompt a user to define the next one or more test scenarios to be run over DUT 140. Exemplary GUI 112 can enable the user to select one or more pre-defined scenarios that are stored in DB 126; to define new scenarios to be created and be stored in DB 126 and/or can be executed immediately. GUI 112 can enable the user to define parameters that are related to the scenario. Parameters such as but not limited to type of transactions (web page fetching transactions, file transfer transactions, email sending/receiving transactions, any combination of those, etc.), the content of a message (file) to be transferred, the size of a message, number of clients, number of servers in the testing scenario, missing packets, bit rates, address ranges, etc. In addition GUI 112 can prompt the user to define requested reports, parameters for success and/or failure, running time, number of repetitions, etc. GUI 112 can be adapted to get reports from TRA 118 and present them to the user.

The user requests are processed by GUI 112 and delivered to TCMM 122. TCMM 122 may determine whether the user requested one or more predefined scenarios that are stored in DB 126 or new ones. If a new scenario is requested, the scenario creator 114 can be invoked in order to create the new scenario. If the requested scenario is stored in DB 126, the scenario is retrieved from the DB 126 with one or more associated scripts. In some exemplary embodiments of the present invention the retrieved scenario can be modified. Exemplary modification can include range of addresses, number of repetitions, range of bit rates, etc. Each script includes a list of a plurality of sequential molds of packets. A mold can be associated with a context. The plurality of molds of packets is transferred via PAPI 128 to PBT 130. PBT 130 may create, from each mold, a stream of a plurality of packets according to the context that is associated with the mold. The streams of the packets are transmitted toward the DUT 140 via communication lines 142 & 146. A context can define a range of addresses of clients; range of addresses of servers; range of URLs; range of bit rates; range of round trip time (RTT); etc.

If the requested test scenario is a new one, which is not stored in DB 126, the scenario creator module 114 is invoked and the user requests are analyzed in order to determine the parameters of the requested scenario. Exemplary parameters can be the type of transactions that are involved in the scenario (one or more “fetching web page” transactions, one or more “mailing” transactions, etc.); the size of files (messages) that are involved in each transactions; range of addresses of clients; range of addresses of servers; range of URLs; range of bit rates; range of round trip time (RTT); etc. According to the type of transactions one or more script generators 116a-c are invoked.

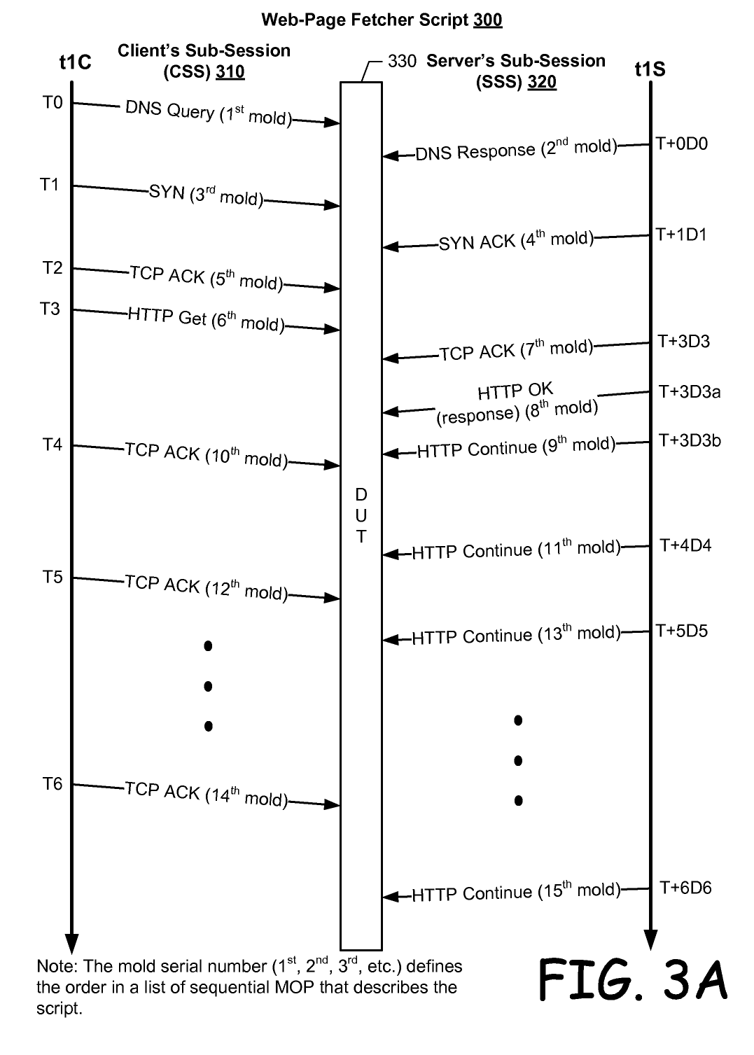

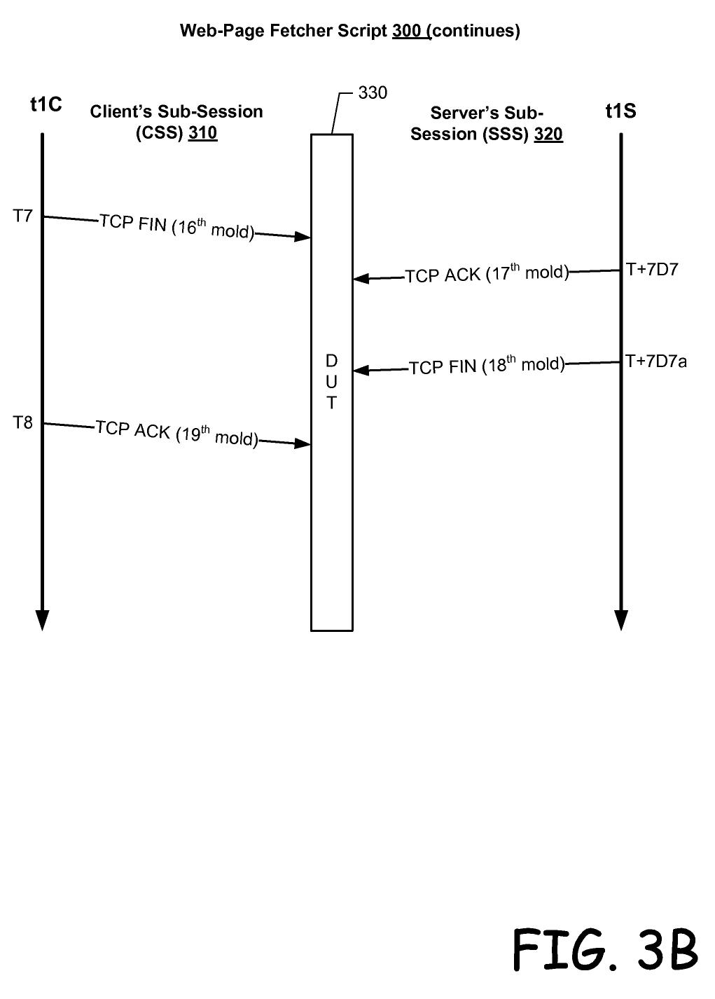

An exemplary page fetcher script generator may get information that is related to a common web page fetching transaction. The information may include information such as but not limited to a plurality of URLs and their associated range of domain names, IP addresses; a plurality of structures of paths, a plurality of web pages in different sizes, latency between a client request and a server response, missing packets simulation, etc. In addition the information may include information that is related to the required scenario, information such as: number of repetitions, bit rates etc. The operation of exemplary page fetcher script generator (PFSG) 116a can be understood in association with the timing diagram 300, which is illustrated in FIG. 3a&b.

PFSG 116a can be capable of processing the above information and delivering a list of molds of packets, each one of the molds of packets can be associated with a context. Based on the list of molds, the PBT 130 can deliver two sequential series of packets as it is illustrated by client sub-session 310 and server sub-session 320. An exemplary script of a web page fetching session can include four stages: a Domain Name Server (DNS) stage, a TCP connection establishment stage, a HTTP stage, and a terminating stage. In an alternate exemplary embodiment of the present invention the DNS stage can be eliminated.

The first two molds in an exemplary list belong to the DNS stage. A first mold can define a DNS query packet. A DNS query mold can include common information such as but not limited to: destination IP address of a DNS server and destination port number 53. In addition, the mold of DNS query can define a source IP address of the first client, and payload. The payload can include a domain name of a first server.

The associated context may include information that defines the stream of packets that will be created based on the mold. The information can include the starting time T0 (FIG. 3a); instruction for changing the source IP address from one packet in the stream to the other; instruction for changing the domain name in the payload from one packet in the stream to the other; bit rate (and/or the time between consecutive packets in the stream), etc. Exemplary instruction for changing a parameter can increase certain bytes of the client IP address by a certain value and continue up to another IP address (the client MAX IP address). Other type of instruction can change certain bytes of the domain name of the first server by a certain value and continue up to another domain name (the MAX domain name), etc. Additional instruction may instruct the PBT 130 to wrap around to an initial value of one or more parameters. Other embodiments may use other algorithms.

PFSG 116a may get the information about the first domain name, the IP address of the first client, T0 (the starting time of the script), the changing function of the domain name and the IP address of the clients, the bit rate, etc., from the scenario. The information is processed and placed in the 1^{st} mold in the appropriate fields of a common DNS query packet and in fields of the context, according to the requirements of UAPI 132 of PBT 130.

A second mold in the list can define the first mold in the server sub-session 320, which is the associated mold of a DNS response packet. A DNS response mold can define: the source address as the IP address of the DNS server that was used in the first mold; the source UDP port number can be 53. The destination IP address of the 2^{nd} mold is the same IP address as the source IP address of the client of the first mold. The payload of the mold can include the associated IP address of the first domain name, which is the IP address of a first web server.

The context may include information that defines the stream of packets, which will be created based on the second mold. Each packet in the stream simulates the DNS response to a relevant packet in the first stream that was created based on the first mold. Therefore, the context of the second mold is related to the context of the first mold. The information can define the delay D0 (FIG. 3) after which the first response packet will be sent; instruction for changing the destination IP address from one packet in the stream to the other (the change can be similar to the change that is used in the source IP address of the first mold); instructions for changing the IP address of the web server in the payload from one packet in the stream to the other; bit rate (and/or the time between consecutive packets in the stream, which can be the same as the one that is used in the first mold), etc.

PFSG 116a may get the information about the delay D0 from the scenario creator 114 (FIG. 1). D0 can represent the RTT (round trip time) of a DNS query. In some embodiment PFSG 116a may calculate the sum of T0+D0 and write the result in the appropriate field of the mold. In other embodiments the time difference between molds can be one parameter that refers to all the molds in the list. Information, such as the IP address of the first web server and the changing function of the IP address of the web server as well as the IP address of clients, the bit rate, etc. can be retrieved from the scenario. The information is processed and placed in the 2^{nd} mold in the appropriate fields of a common DNS response packet and in the fields of the context, according to the requirements of UAPI 132 of PBT 130.

The next three molds, the 3^{rd}, 4^{th} and 5^{th} molds, are relevant to the second stage of a web page fetching transaction. The three molds simulate the three way handshake packets that are transferred between a client and a server in order to establish a TCP connection. The 3^{rd} mold (FIG. 3a) is a mold of a SYN packet. A mold of a SYN packet can include common information such as but not limited to: destination TCP port 80, SYN flag, sequence number etc. In addition, the mold can define the first source IP address as the IP address of the first client, a first source port number; and the IP address of the first web server as the destination IP address.

The context of the 3^{rd} mold is related to the context of the previous molds. The information can include the time T1 (FIG. 3), which is bigger than T0+D0; instruction for changing the source IP address from one packet in the stream to the other (the change can be similar to the change that is used in the source IP address of the first mold); instruction for changing the source port number from one packet in the stream to the other; instruction for changing the IP address of the web server from one packet in the stream to the other (the change can be similar to the change of the web server IP address that is used in the second mold); bit rate (the time between consecutive packets in the stream), etc.

In order to create the 3^{rd} mold PFSG 116a can retrieve from the scenario information about the T1, IP address of the first web server and the changing function of the IP address of the web server as well as the clients, the bit rate, etc. The information is processed and placed in the 3^{rd} mold in the appropriate fields of a common SYN packet and in the appropriate fields of the context, according to the requirements of UAPI 132 of PBT 130. In some embodiment of the present invention the time interval between consecutive molds of packets in the list remains without changing for a cycle of the test.

The 4^{th} mold of packet is a mold of a SYN-ACK packet. A SYN-ACK packet is sent by a web server in response to the SYN packet. A SYN-ACK mold can define the IP address of the first web server as the first source IP address of the stream, a first web server source port number 80, etc. The defined first destination IP address can be the first client IP address and the first destination port number can be the same as the first client source port number that was defined in the 3^{rd} mold. The context may include information that defines the stream of packets, which will be created based on the 4^{th} mold.

The context of the 4^{th} mold is related to the context of the previous molds. The information can define the time T1+D1 (FIG. 3a); instruction for changing the destination IP address from one packet in the stream to the other (the change can be similar to the change that is used in the source IP address of the 3^{rd} mold); instruction for changing the destination TCP port number from one packet in the stream to the other (the change can be similar to the change that is used in the source port of the 3^{rd} mold); instruction for changing the source IP address from one packet in the stream to the other (the change can be similar to the change that is used in the destination IP address of the 3^{rd} mold); bit rate (and/or the time between consecutive packets in the stream, which can be the same as the one that is used in the first mold), etc.

The 5^{th} mold (FIG. 3a) is a mold of a TCP ACK packet. A TCP ACK packet is sent by a client in response to the SYN-ACK packet from a web server. After sending the TCP ACK packet a TCP connection is established between the client and the web server. A TCP ACK mold can define the IP address of the first client as the first source IP address of the stream, the first source port number that is used in the 3^{rd} mold (the TCP SYN mold). The defined first destination IP address is the first web server IP address. The context may include information that defines the stream of packets, which will be created based on the 5^{th} mold.

The context of the 5^{th} (FIG. 3a) mold is related to the context of the previous molds. The information can define the time T2, which is bigger than T1+D1; instruction for changing the source and destination IP address and ports from one packet in the stream to the other (in a similar way to the change that is disclosed above); bit rate (the time between consecutive packets in the stream, which can be the same as the one that is used in the first mold), etc.

Upon execution of the stream of packets that are related to the first 5 molds by PBT 130 (FIG. 1), then the DUT 140 can observe a plurality of TCP connections between a plurality of clients (starting from the IP address of the first client to the MAX IP address of the last client) and a plurality of web servers (starting from the IP address of the first web server to the MAX IP address of the last web server).

Referring now to the 3^{rd} stage of web page fetching transaction, the HTTP stage. During this stage fetching the requested markup language (ML) file (an HTML file, for example), which describes the requested web-page, is simulated.

In one exemplary embodiment of the present invention GUI 112 can prompt the user to select a predefined ML file from a plurality of ML files, which are stored in DB 126. The selection can be based on features like size, etc. Another exemplary embodiment of the present invention enables the user to deliver a requested ML file and its associated images.

The 3^{rd} stage of a web page fetching script 300 starts with the 6^{th} mold in the list, which defines a HTTP Get command. A mold of HTTP Get can include common information such as but not limited to: host name, a path to the requested file, a content type, a cookie, etc. In addition, the mold can define the source IP address of the first client; the first source port number; the IP address of the first web server as the destination IP address; the destination port number 80.

The context of the 6^{th} (FIG. 3a) mold is related to the context of the previous molds. The information can include the time T3; instruction for changing the source IP address from one packet in the stream to the other (the change can be similar to the change that is used in the source IP address of the first mold); instruction for changing the source port number from one packet in the stream to the other; instruction for changing the IP address of the web server from one packet in the stream to the other (the change can be similar to the relevant change that is used in the 3^{rd} mold); bit rate (and/or the time between consecutive packets in the stream), etc.

The 7^{th} mold defines a TCP ACK packet. A TCP ACK mold can define the IP address of the first web server as the first source IP address of the stream, a first web server port number 80; the defined first destination IP address can be the first client's IP address; the first destination port number can be the first client source port number that was defined in the 3^{rd} mold. In addition the 7^{th} mold, the TCP ACK mold, can include an acknowledgement number, which is a function of the 6^{th} mold sequence number and the length of the TCP payload that was part of the 6^{th} mold. The acknowledgement number of the 7^{th} mold reflects an acknowledgement sequence number that would have been generated by a web server participating in such a TCP connection.

The context of the 7^{th} mold is related to the context of the previous molds. The information can define the time T3+D3; instruction for changing the destination IP address from one packet in the stream to the other (the change can be similar to the change that is used in the source IP address of the first mold); instruction for changing the destination IP port number from one packet in the stream to the other (the change can be similar to the change that is used in the source port of the 3^{rd} mold); instruction for changing the source IP address from one packet in the stream to the other (the change can be similar to the change that is used in the destination IP address of the 3^{rd} mold); bit rate that can be the same as the one that is used in the first mold, etc.

In order to blast the DUT 140 with packets carrying data of a retrieved web page an exemplary PFSG 116a may fetch the requested ML file from DB 126; divide it into chunks of data each one in a size below the maximum size of a TCP packet (1460 bytes, for example). Then, PFSG 116a may create the next molds in the script 300.

The 8^{th} mold defines a HTTP OK packet which simulates a response of the web server to the HTTP get packet. A HTTP OK mold can define the IP address of the first web server as the first IP source address of the stream; the defined first destination IP address can be the first client's IP address; the first destination port number can be the first client source port number that was defined in the 3^{rd} mold. The acknowledgement number of the 8^{th} mold can be similar to the acknowledgement number of the 7^{th} mold. The payload of the HTTP OK packet can define the size of the retrieved markup language (ML) file that describes the web-page, an HTML file, for example. In some cases the payload may include the first chunk of data of the ML file. The context may include information that defines the stream of packets, which will be created based on the 8^{th} mold. The context of the 8^{th} mold is related to the context of the previous molds. The information can define the time T3+D3a; the rest of the context can be similar to the context of the 7^{th} mold of packets.

The following 9^{th} to 15^{th} molds in the list of script 300 can define a plurality of molds of HTTP Continue packets and TCP ACK packets. Each one of the following molds in the SSS 320 side of the script is a mold of HTTP Continue packet. A mold of HTTP Continue packet simulates a packet that carries a next data chunk of the requested web-page from a web server to a client. The following portion of CSS 310 side of the script 300 includes molds of TCP ACK packets.

Each TCP mold in the script 300 (FIG. 3a&b) includes a sequence number, which is a function of the sequence number of the previous mold of the same sub-session (client or web server) and the length of the payload of the previous mold of the same sub-session. In addition each mold includes an acknowledgement number that is a function of the sequence number and the payload length of the latest preceding mold of the other sub session.

An exemplary HTTP Continue mold can define the IP address of the first web server as the first source IP address of the stream; the defined first destination IP address can be the first client's IP address; the first destination port number can be the first client source port number that was defined in the 3^{rd} mold. The sequence number of the mold can be a function of the sequence number and the length of the payload of the previous mold in SSS 320 (FIG. 3). The acknowledgement number can be a function of the sequence number and the length of the payload of the previous molds of CSS 310. The payload of the HTTP Continue packet can contain a next chunk of data of the ML file. The context of a HTTP Continue mold is related to the context of the previous molds. The information can define the relevant time; the rest of the context can be similar to the context of the 7^{th} mold of packets.

An exemplary client TCP ACK mold (12^{th} mold, for example) can define the IP address of the first web server as the first destination IP address of the stream; the defined first source IP address can be the first client IP address; the first source port number can be the first client source port number that was defined in the 3^{rd} mold. The sequence number of the mold can be a function of the sequence number and the length of the payload of the previous mold in CSS 310 (FIG. 3). The acknowledgement number can be a function of the sequence number and the length of the payload of the previous molds of SSS 320. The TCP ACK packet contains no payload. The context of a TCP ACK mold is related to the context of the previous molds. The information can define the relevant time; the rest of the context can be similar to the context of the 3^{rd} mold of packet.

The 15^{th} mold simulates a packet that carries the last data chunk of the requested web page. Therefore, after the 15^{th} mold PFSG 116a continues to the last stage of a web page fetching transaction and starts the termination session with the 16^{th} mold. The termination stage is described in association with FIG. 3b. In order to simulate a termination of the fetching transaction PFSG 116a may add the 16^{th} mold of a TCP FIN packet to the list. The 16^{th} mold defines a TCP FIN packet. A mold of TCP FIN can similar to the 14^{th} mold with a distinction that the TCP FIN flag, in the TCP header, is set.

The context of the 16^{th} (FIG. 3b) mold is related to the context of the previous molds. The information can include the time T7; instruction for changing the source IP address from one packet in the stream to the other (the change can be similar to the change that is used in the source IP address of the first mold); instruction for changing the source port number from one packet in the stream to the other; instruction for changing the IP address of the web server from one packet in the stream to the other (the change can be similar to the relevant change that is used in the 3^{rd} mold); bit rate (the time between consecutive packets in the stream), etc.

The 17^{th} (FIG. 3b) mold of packets is a TCP ACK mold. The 17^{th} mold can be similar to the 7^{th} mold, which is described above. The 18^{th} mold defines a web server's TCP FIN packet which is similar to the 7^{th} mold with a distinction that the TCP FIN flag, in the TCP header, is set. The context of the 18^{th} mold is related to the context of the previous molds. The information can define the time T7+D7a; the rest of the context can be similar to the context of the 17^{th} mold of packets. The last mold, the 19^{th} mold, in the list of script 300 is the TCP ACK mold of packets. The mold is similar to the previous TCP ACK mold of CSS 310, mold 14^{th} (FIG. 3a).

The list of the molds and associated context that was created by PFSG 116a can be stored in SM 124 in order to be used immediately and/or can be stored in the DB 126 to be used later. The TCMM 122 can be updated and PFSG 116a can be released until another page fetching script is required.

Exemplary PFSG 116a can generate other types of page-fetching-scripts according to the testing scenario. For example, a script that may include: a plurality of HTTP Get commands; two or more TCP connections; missing packets; etc. The operation of the other script generators 116b&c can be similar to the operation of PFSG 116a with some modifications that are related to the type of transaction that is simulated such as port number, domain name, payload format etc.

Other exemplary scenarios may simulate problematic events, such as but not limited to missing packets, retransmissions, etc. In such scenarios the simulated sequence number and/or the acknowledgement number of a mold may depend on a plurality of preceding molds. For example, in a scenario simulating the loss of a server response packet such as the 9^{th} mold in FIG. 3a, following client side ACK packets such as the 10^{th} and 12^{th} molds may be configured to carry identical acknowledgement numbers, reflecting the sequence number of the last contiguous byte received from the server side based on sequence number and payload length of the 8^{th} mold (and possibly molds preceding the 8^{th} mold). If a retransmission of the missing packet is simulated between the 12^{th} and 13^{th} mold, acknowledgement numbers of the following molds of packets in both sub-sessions may proceed from this point as in the original scenario. Other scenarios may simulate other events such as missing a plurality of packets, time-outs, etc.

TCMM 122 is the logical module that manages the operation of the testing system 100. It may invoke each one of the logical modules of TCM 110 in order to control the operation of the testing system. It may utilize the GUI 112 for interfacing with a user, the scenario creator 114 for processing the user request into testing scenario, that later will be converted into one or more lists of molds of packets by one or more script generators 116a-c. In order to communicate with the PBT 130, TCMM 122 may invoke the PAPI 128. Via PAPI, TCMM 122 may transfer the molds of packets, testing instructions and receive testing reports.

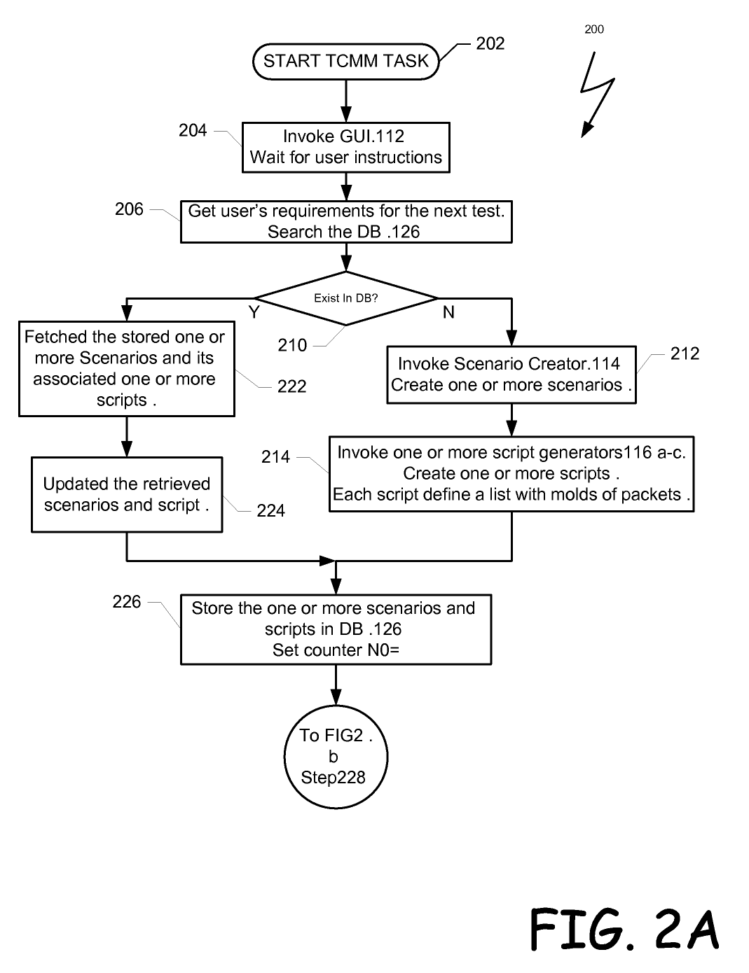

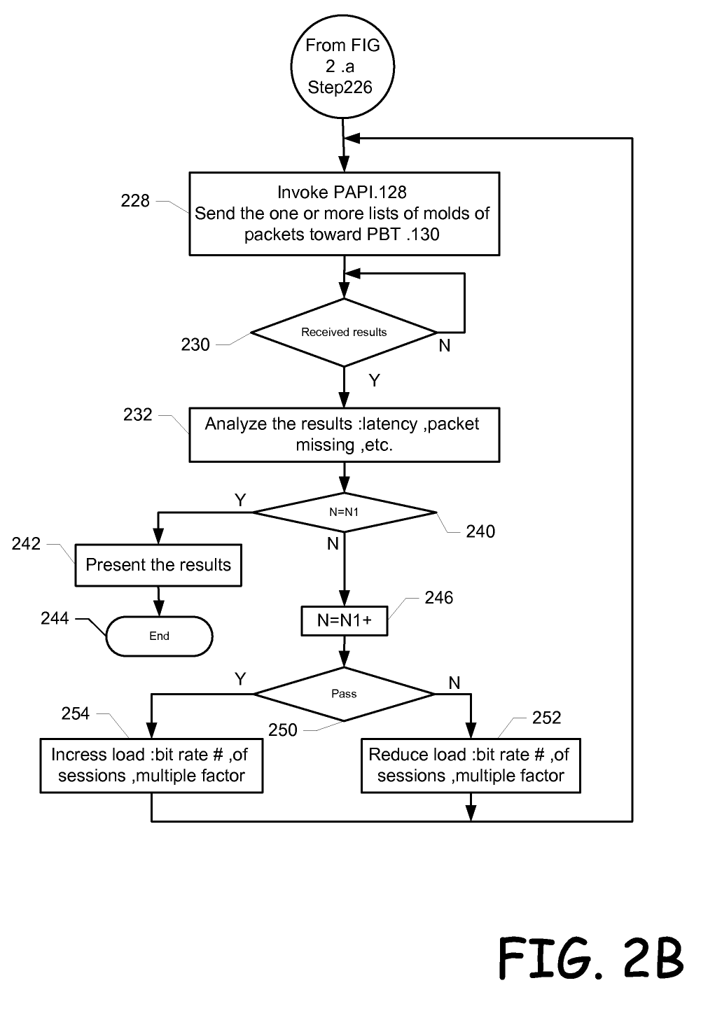

During a test process, TRA 118 can be invoked by TCMM 122 in order to analyze testing results that have been received from PBT 130 and prepare reports. The processed results such as latency, missing packets, etc. can be transferred to TCMM 122. The result can be associated with some relevant parameters. Exemplary relevant parameters can identify the relevant stream, the bit rate, the network port, etc. Based on the reports and the user's instructions, TCMM 122 may determine how to proceed, which parameter of the testing scenario can be changed, etc. More information on the operation of TCMM 122 is disclosed below in conjunction with FIG. 2a&b.

FIG. 2a&b illustrate a flowchart showing relevant processes of an exemplary method 200 for emulating stateful testing by implementing a stateless tester PBT 130. Method 200 can be managed by TCMM 122. Method 200 can be initiated 202 on power up and can run as long as TCM 110 is active. Following initiation, method 200 can invoke GUI 112 and may wait 204 until a user's instructions are received. Upon receiving the user's instructions, the instructions are analyzed 206 and the DB 126 is searched for a similar scenarios. At step 210 a decision is made whether one or more scenarios, which are stored in DB 126, are similar to the requested test.

If yes, the one or more similar scenarios and their associated scripts (list of molds and context) are fetched 222 from the DB 126. The retrieved scenario can be parsed 224 and modified in order to match the user's requirements. The modification can include updating the bit rate to a requested one, changing the interval of the client's IP address and/or port, changing the interval of the server's IP address and/or port, changing the success criteria, etc. The modified scenarios and its associated scripts can be stored 226 in DB 126, a counter N can be reset to zero. Counter N is used in order to count the number of runs during the next test. Then method 200 proceeds to step 228, which is illustrated in FIG. 2b, and sends the updated scripts (list of molds of packets and their associated context) via PAPI 128 to the PBT 130.

Returning now to step 210, if a similar script is not stored in DB 126 scenario creator 114 is invoked 212. The user requirements, which have been collected by GUI 112, are processed by the scenario creator in order to generate one or more scenarios. Upon creating the new scenarios, one or more script generators 116a-c are invoked 214 in order to convert the testing scenarios into one or more scripts. The number of the scripts generators 116a-c and their types depend on the test scenario. A script can describe a list of a plurality of molds of packets. Each mold of packets can be associated with a context. The mold of packet and its context define a stream of packets that later will be created by PBT 130 and be sent towards DUT 140. More information on the operation of the scenario generator 114 and the script generators 116a-c is disclosed above in conjunction with FIG. 1.

The new scenarios and their associated scripts can be stored 226 in DB 126, counter N can be reset to zero and method 200 proceeds to step 228, which is illustrated in FIG. 2b.

At step 228 the PAPI 128 is invoked, one or more lists of molds of packets and their associated context are transferred to PAPI 128 to be processed according to the requirements of PBT 130 and be sent to PBT 130. Information of the required results is transferred 228 toward the PBT 130. Then method 200 may wait 230 for receiving results from PBT 130 via PAPI 128. The results can be analyzed 232 by TRA 118 and be transferred to TCMM 122 according to predefined success criteria. Then, a decision is made 240 whether N is equal to a certain parameters N1. N1 can be requested by the user or in other embodiment it can be a default value. The parameter N1 defines number of testing cycles.

If 240 N is equal to N1, then reports about latency; missing packets; relevant streams and ports; etc. can be presented 242 via GUI 112 to the user and method 200 can be terminated 244. If N is not equal to N1, then counter N is incremented by one 246 and a new testing cycle can be initiated. In an embodiment of the present invention the next testing cycle can be adapted to the result of the previous one. For example, a decision is made 250 whether the previous test succeeded. A test can succeed if the latency was below a predefine value, if the missing packets were below a certain value or no missing packets, etc.

If 250 the previous test succeeded then, TCMM 122 may change some testing parameters 254 in order to increase the throughput of packets that PBT 130 (FIG. 1) will send toward the DUT 140. One or more of the list of molds can be modified: bit rate can be increased; the range of client and/or server IP addresses can be increased, etc. If 250 the previous test failed then, TCMM 122 may change testing parameters 252 in one or more lists of molds in order to reduce the throughput of packets that PBT 130 (FIG. 1) will send toward the DUT 140. For example, the bit rate can be reduced; the range of client and/or server IP addresses can be decreased, etc. Then method 200 may return to step 228 for launching the new testing cycle.

In the present disclosure, the words “unit,” “element,” “module” and “logical module” can be used interchangeably. Anything designated as a unit or module can be a stand-alone unit or a specialized or integrated module. A unit or a module can be modular or have modular aspects allowing it to be easily removed and replaced with another similar unit or module. Each unit or module may be any one of, or any combination of, software, hardware, and/or firmware.

It will be appreciated that the above described apparatus and methods may be varied in many ways, including, changing the order of steps, and the exact implementation used. The described embodiments include different features, not all of which are required in all embodiments of the present disclosure. Moreover, some embodiments of the present disclosure use only some of the features or possible combinations of the features. Different combinations of features noted in the described embodiments will occur to a person skilled in the art. Furthermore, some embodiments of the present disclosure can be implemented by combination of features and elements that have been described in association to different exemplary embodiments along the discloser. The scope of the invention is limited only by the following claims.

What is claimed is:

1. A method for testing a network device, by using a stateless testing device, a packet blaster tester (PBT), in a simulated stateful scenario, the method comprising:
configuring the PBT to transmit a plurality of groups of packets toward the network device according to a script, wherein each group comprises two series of sequential packets a first series and a second series, wherein the first series comprises packets that simulate packets that would have been sent by a client application toward a server via the network device while the second series comprises simulated packets that would have been sent by the server in response to receiving packets of the first series; wherein packets of the second series are sent by the PBT according to the script regardless of the packets that are sent by the network device in response to receiving the packets of the first series.

2. The method of claim 1, wherein the first series further comprising simulated packets that would have been sent by the client in response to receiving packets of the second series; wherein packets of the first series are sent by the PBT according to the script regardless of the packets that have been sent by the network device in response to receiving the packets of the second series.

3. The method of claim 1, wherein the step of configuring further comprising the steps of:
i. creating, according to the script, a list of consecutive molds, each mold is associated with context, wherein the list of consecutive molds defines the plurality of groups of packets;
ii. delivering the list of consecutive molds to the PBT.

4. The method of claim 3, wherein each mold and its associated context defines a packet of a first group of packets from the plurality of groups of packets and information to be used by the PBT in order to modify the packet of the first group in order to create a similar packet for each one of the other groups of packets.

5. The method of claim 4, further comprising at the PBT:
receiving the list of molds and context;
creating a stream of packets per each mold; and
transmitting the streams of packets toward the network device.

6. An apparatus for configuring a stateless testing device for testing a network device in a simulated stateful scenario, the apparatus comprising:
a. a user interface module capable of receiving user requests;
b. a script generator capable of creating a list of consecutive molds of packets and associated context according to the user requests; and
c. an API module capable of processing the list of consecutive molds according to the needs of the stateless testing device and delivering the processed list to the stateless testing device;
wherein the list of consecutive molds comprises two series of sequential molds of packets and associated context, a first series and a second series, wherein the first series comprises molds of packets that simulate packets that would have been sent by a client application toward a server via the network device while the second series comprises molds of simulated packets that would have been sent by the server in response to receiving packets created according to the first series; wherein packets of the second series are sent by the stateless testing device according to the list regardless of the packets that are sent by the network device in response to receiving the packets of the first series.

7. A system for testing a network device by a stateless testing device for testing in a simulated stateful scenario, the system comprising:
a. a stateless testing device; and
b. a configuration module capable of configuring the stateless testing device to create simulated stateful traffic toward the network device;
wherein the simulated stateful traffic comprises a plurality of groups of packets according to a predefine script, wherein each group comprises two series of sequential packets a first series and a second series, wherein the first series comprises packets that simulate packets that would have been sent by a client application toward a server via the network device while the second series comprises simulated packets that would have been sent by the server in response to receiving packets of the first series; wherein packets of the second series are sent by the stateless testing device according to the predefine script regardless of the packets that are sent by the network device in response to receiving the packets of the first series.
